(19) United States
(12) Patent Application Publication
(10) Pub. No.: US 2024/0249126 A1
(43) Pub. Date: Jul. 25, 2024

(54) ENTITY UNIFICATION IN DISTRIBUTED COMPUTING

(71) Applicant: INTERNATIONAL BUSINESS MACHINES CORPORATION, ARMONK, NY (US)

(72) Inventors: Shriti Priya, WHITE PLAINS, NY (US); Julian James Stephen, Yorktown Heights, NY (US); Arjun Natarajan, Old Tappan, NJ (US)

(21) Appl. No.: 18/158,515

(22) Filed: Jan. 24, 2023

(51) Int. Cl. G06N 3/063; G06Q 30/04

(52) U.S. Cl. CPC G06N 3/063; G06Q 30/04

(57) ABSTRACT

Described are techniques for coalescing duplicative representations of entities in knowledge graphs. The techniques include unifying a first representation of a first entity with a second representation of the first entity in a knowledge graph of a cloud environment based on the first representation and the second representation sharing a predefined configuration of attributes. The techniques further include unifying a third representation of a second entity with a fourth representation of the second entity in the knowledge graph based on a temporal activity signature of the third representation being matched to the fourth representation by a Long-Short Term Memory (LSTM) network model. The techniques further include outputting the knowledge graph with a first unified representation of the first entity based on the first representation and the second representation and a second unified representation of the second entity based on the third representation and the fourth representation.

### BACKGROUND

The present disclosure relates to distributed computing management, and, more specifically, to unifying multiple representations of a same entity into a single representation for distributed computing management.

The growing number of security threats and security-related regulations surrounding cloud-based infrastructures and services (e.g., distributed computing) has necessitated that cloud providers utilize an array of solutions (e.g., cybersecurity tools, asset management tools, etc.) to monitor, manage, and/or mitigate security threats. Furthermore, advanced security paradigms (e.g., Zero Trust) require that data from disparate cybersecurity tools be holistically evaluated. However, temporal and representational differences between data collected from a same entity by different cybersecurity tools makes it difficult to combine data aggregated from the same entity by the different cybersecurity tools. Said another way, attribute values of a given entity can change over time and/or different cybersecurity tools can view the given entity differently. These differences can result in fragmented (rather than unified) data for the given entity, thereby reducing the security of the given entity and its associated cloud environment.

Traditional entity identification for cybersecurity tool and/or asset management purposes typically relies on (i) registering assets using a provided Application Programming Interface (API), and/or (ii) scanning ports/Internet Protocol (IP) addresses to identify potential entities. However, such techniques do not resolve the issue of a same entity being differently represented based on the tool that identified the entity.

Graph similarity matching using graph algorithms (e.g., graph edit distance, maximum common subgraph, graph isomorphism, belief propagation, etc.) can be used to attempt to unify multiple representations of a same entity, however, these solutions are unreliable in situations where a same entity can be associated with different names and/or titles by different tools. Furthermore, graph similarity matching using graph algorithms can be prohibitively computationally expensive when faced with a graph representing all entities associated with a cloud environment.

Graph similarity matching using machine learning (e.g., graph embedding, graph neural networks, deep graph kernels, etc.) can be used to unify multiple representations of a same entity, however, these techniques experience significant performance deterioration when used on dynamic and/or streaming graphs. In other words, the aforementioned techniques are poor at encoding temporal information and/or updates to entities represented in a graph and are therefore unable to effectively unify multiple representations of a same entity in a dynamic environment such as a cloud environment.

### SUMMARY

Aspects of the present disclosure are directed toward a computer-implemented method comprising unifying a first representation of a first entity with a second representation of the first entity in a knowledge graph of a cloud environment based on the first representation and the second representation sharing a predefined configuration of attributes. The method further comprises unifying a third representation of a second entity with a fourth representation of the second entity in the knowledge graph based on a temporal activity signature of the third representation being matched to the fourth representation by a Long-Short Term Memory (LSTM) network model. The method further comprises outputting the knowledge graph with a first unified representation of the first entity based on the first representation and the second representation and a second unified representation of the second entity based on the third representation and the fourth representation.

Advantageously, the aforementioned method can coalesce duplicative representations of the same entity in a knowledge graph of a cloud environment, thereby improving the accuracy of the knowledge graph. In turn, an accurate knowledge graph of a cloud environment can be used to implement, comply with, and/or provide proof of compliance with: best practices, legal regulations, industry standards, and/or contractual obligations (e.g., Service Level Agreements), for example. More specifically, the two strategies of coalescing entities described above are efficient and accurate. The first strategy related to a shared predefined configuration of attributes is a computationally inexpensive method to coalesce duplicative representations of a same entity with shared attribute characteristics. Meanwhile, the second strategy related to the LSTM network model is a more robust strategy that can identify duplicative representations of a same entity despite different configurations of attributes.

In some additional aspects of the present disclosure related to the aforementioned method, the predefined configuration of attributes comprises a workload deployment name and a container image name. Advantageously, using the workload deployment container name and the container image name to identify duplicative instances of a same entity in a cloud environment is accurate and relatively computationally inexpensive.

In some additional aspects of the present disclosure related to the aforementioned method, the third representation of the second entity and the fourth representation of the second entity are associated with different Internet Protocol (IP) addresses. Advantageously, this aspect of the present disclosure clarifies that the LSTM network model is capable of coalescing duplicative representations of a same entity even when those duplicative representations are associated with different IP addresses.

In some additional aspects of the present disclosure related to the aforementioned method, the third representation of the second entity and the fourth representation of the second entity are associated with different hostnames. Advantageously, this aspect of the present disclosure clarifies that the LSTM network model is capable of coalescing duplicative representations of a same entity even when those duplicative representations are associated with different hostnames.

Additional aspects of the present disclosure are directed to systems and computer program products configured to perform the method described above. The present summary is not intended to illustrate each aspect of, every implementation of, and/or every embodiment of the present disclosure.

### BRIEF DESCRIPTION OF THE DRAWINGS

The drawings included in the present application are incorporated into and form part of the specification. They illustrate embodiments of the present disclosure and, along with the description, serve to explain the principles of the disclosure. The drawings are only illustrative of certain embodiments and do not limit the disclosure.

FIG. 1 illustrates a block diagram of an example computational environment implementing cloud management code, in accordance with some embodiments of the present disclosure.

FIG. 2A illustrates an example data feed of an application in a cloud environment, in accordance with embodiments of the present disclosure.

FIG. 2B illustrates an example cloud environment graph generated from numerous data feeds, in accordance with embodiments of the present disclosure.

FIG. 3 illustrates a flowchart of an example method for unifying multiple discrete representations of a same entity in a cloud environment graph, in accordance with embodiments of the present disclosure.

FIG. 4 illustrates example computer code for identifying multiple representations of a same entity using attributes, in accordance with some embodiments of the present disclosure.

FIG. 5 illustrates a flowchart of an example method for identifying multiple representations of a same entity using a Long-Short Term Memory (LSTM) network model, in accordance with some embodiments of the present disclosure.

FIG. 6 illustrates example computer code for identifying multiple representations of a same entity using the LSTM network model, in accordance with some embodiments of the present disclosure.

FIG. 7 illustrates a flowchart of another example method for unifying multiple discrete representations of a same entity in a knowledge graph of a cloud environment, in accordance with some embodiments of the present disclosure.

FIG. 8 illustrates a flowchart of an example method for downloading, deploying, metering, and billing usage of cloud management code, in accordance with some embodiments of the present disclosure.

FIG. 9 illustrates a diagram of experimental results obtained by implementing cloud management code, in accordance with some embodiments of the present disclosure.

FIG. 10 illustrates a block diagram of an example computing environment, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure are directed toward distributed computing management, and, more specifically, to unifying multiple representations of a same entity into a single representation for distributed computing management. While not limited to such applications, embodiments of the present disclosure may be better understood in light of the aforementioned context.

Applications deployed in cloud native, microservice-based environments undergo frequent changes while being scanned by multiple security solutions (e.g., vulnerability detection tools, data protection tools, risk evaluation tools, etc.). Different tools and/or logging systems can view the same entity in different ways, resulting in multiple representations for the same entity in a knowledge representation system (e.g., knowledge graph, cloud environment ontology, cloud environment schema, cloud environment graph, etc.). Aspects of the present disclosure are directed to techniques for coalescing different representations of a same entity based on a set of cloud-specific heuristics, entity relationships, and/or machine learning.

To further elucidate the challenges resolved by aspects of the present disclosure, several example scenarios are now discussed. These scenarios can relate to events on a web application that stores data in a traditional Structured Query Language (SQL) database back-end. Each scenario describes a case where two runtime instances of an application are identified as different entities, and where aspects of the present disclosure can unify the two runtime instances of the application into a same entity.

In a first example scenario, a web application is running in a cluster. Users login to the application, and the application queries a database to service user requests. After several days of activity, a system administrator redeploys the application in a new cluster/namespace (e.g., with a different Internet Protocol (IP) address, a different hostname, etc.). Traditionally, the initially deployed web application and the subsequently redeployed web application would be identified as different entities based on the different IP addresses and/or different hostnames, for example. Aspects of the present disclosure can identify the initially deployed web application and the subsequently redeployed web application as the same entity and unify the initially deployed web application and the subsequently redeployed web application into a single representation.

In a second example scenario, an application has multiple data feeds defining its behavior such as a threat feed (e.g., from QRADAR®), a vulnerability feed (e.g., from Quai.io), and a data activity feed (e.g., from Guardium®). Traditionally, each of the data feeds can separately represent the application. Aspects of the present disclosure can identify the application from each of the three data feeds and unify the separate representations of the application from each of the three data feeds.

In a third example scenario, an application is deployed as a microservice in a Kubernetes® cluster. A data proxy between the application and a database can log the application IP address and the query the application issues against the database. When the application microservice restarts, it is assigned a new IP address and the data proxy begins logging the new IP address. Traditionally, the data proxy would represent the application in the initially deployed microservice as a distinct entity from the application in the restarted microservice. However, aspects of the present disclosure can unify the representations of the application in the initially deployed microservice and the application in the restarted microservice.

In a fourth example scenario, an application microservice is automatically deployed in multiple geographic locations (e.g., each in a respective Kubernetes® cluster) for load balancing and/or fault tolerance purposes. Traditionally, the application microservice would be discretely represented for each geographic deployment. However, aspects of the present disclosure can unify the representations of the application microservice in each distinct geographic location (and each distinct Kubernetes® cluster, for example).

As discussed herein, an application can be defined as any active or running instance of program source code. Two application entities can be the same if they perform the same set of logical operations (e.g., the same application source code albeit with different configurations). Aspects of the present disclosure are directed to identifying a same entity represented differently in different tools and/or services by (i) using a fixed attribute-based algorithm and/or (ii) using an activity based Long Short-Term Memory (LSTM) technique. The LSTM technique can utilize LSTM-based graph similarity matching and an encoding for temporal updates to entities (and/or their interactions). The LSTM technique can be generalizable to many knowledge representation techniques, ontologies, and/or schemas. Notably, aspects of the present disclosure can be performed without access to application binaries or source code. Consequently, aspects of the present disclosure do not modify application binaries or source code.

Advantageously, aspects of the present disclosure enable data for a same entity from different domains (e.g., collected by different tools such as different cybersecurity tools and/or asset management tools) to be coalesced, thereby increasing the accuracy of knowledge graphs representing those entities. Doing so creates a foundation for providing Zero Trust-based security paradigms in cloud environments. Furthermore, the solution provided by the present disclosure utilizes a two-part technique—a first part using a fixed length attribute-based algorithm and a second part using an LSTM technique. The first part (fixed length attribute-based algorithm) is a relatively lightweight and efficient way to identify a same entity in data from different domains. Meanwhile, the second part (LSTM technique) is relatively more computationally expensive but also relatively more capable of identifying a same entity in data from different domains by evaluating temporal and structural characteristics. In this way, aspects of the present disclosure strike a balance between computational efficiency and accuracy while overcoming the technical challenge of unifying duplicative instances of a same entity in cloud environment knowledge graphs.

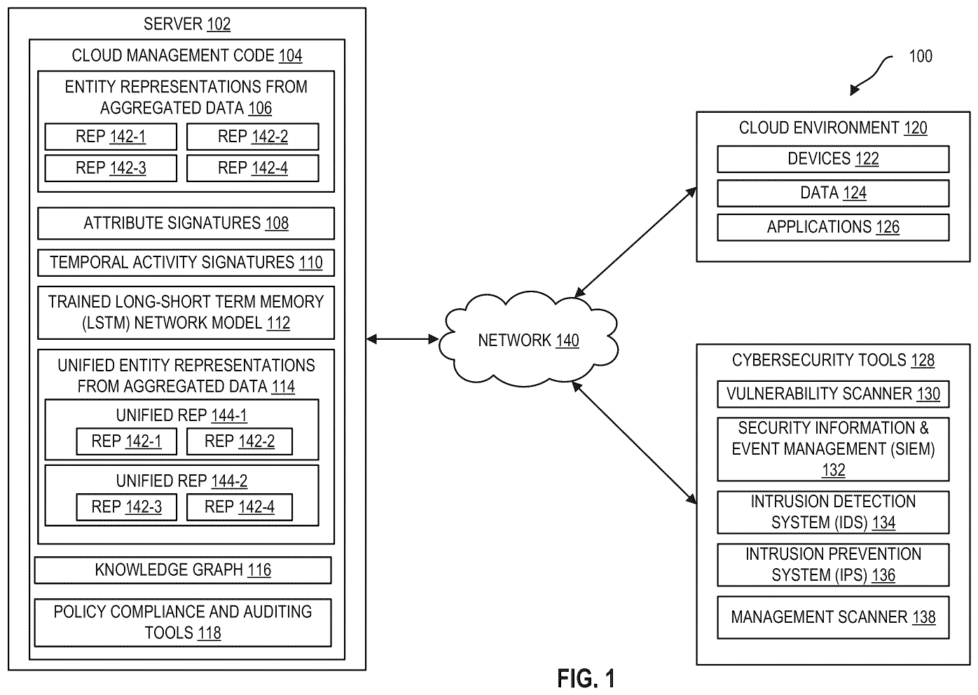

FIG. 1 illustrates a block diagram of an example computational environment 100 implementing cloud management code 104, in accordance with some embodiments of the present disclosure. The example computational environment 100 includes a server 102 communicatively coupled to a cloud environment 120 and cybersecurity tools 128 via a network 140.

Server 102 can be any computational configuration of hardware and/or software capable of implementing cloud management code 104. In some embodiments, server 102 can be any server, computer, mainframe, or other combination of computer hardware capable of executing software. In some embodiments, server 102 can be a virtual machine (VM), container instance, or other virtualized combination of discrete physical hardware resources.

Cloud environment 120 can be a public cloud environment, private cloud environment, and/or hybrid cloud environment. Cloud environment 120 can include devices 122, data 124, applications 126, and/or other elements of a distributed-computing environment. Devices 122 can refer to networking devices (e.g., switches, routers, etc.), processing devices (e.g., modems, terminals, servers, processors, etc.), storage devices (e.g., disk drives, Flash drives, tape drives, etc.), and/or other devices useful for providing the hardware infrastructure to support cloud environment 120. Data 124 can refer to various types of data stored on, processed by, and/or transmitted between devices 122. Applications 126 can refer to executable software code that processes data 124 using devices 122 to achieve a desired result for a user. In various embodiments, any of devices 122, data 124, and/or applications 126 can be considered an entity.

Cybersecurity tools 128 can include, for example, vulnerability scanner 130, Security Information and Event Management (SIEM) 132, Intrusion Detection System (IDS) 134, Intrusion Prevention System (IPS) 136, management scanner 138, and/or other tools, scanners, loggers, and/or systems useful for asset management and/or cybersecurity management of cloud environment 120.

The network 140 can be a local area network (LAN), a wide area network (WAN), an intranet, the Internet, or any other network 140 or group of networks 140 capable of continuously, semi-continuously, or intermittently connecting (directly or indirectly) the aforementioned components together.

Referring back to cloud management code 104, it can receive entity representations from aggregated data 106. Entity representations from aggregated data 106 can be the data aggregated from cybersecurity tools 128, and it can include duplicative representations of similar entities (e.g., SIEM 132 and IDS 134 can generate discrete representations of the same entities related to devices 122, data 124, and/or applications 126). For example, entity representations from aggregated data 106 can include a first representation 142-1, a second representation 142-2, a third representation 142-3, and a fourth representation 142-4 (collectively referred to as representations 142). Notably, the representations 142 all appear to be related to discrete entities in cloud environment 120 when, in fact, two or more of representations 142 can be duplicative instances of a same entity in cloud environment 120.

Cloud management code 104 can be further configured to generate attribute signatures 108 for each representation 142 of the entity representations from aggregated data 106. The attribute signatures 108 can be a fixed length set of attributes related to configuration parameters for each of the representations 142. In some embodiments, the attribute signatures 108 can be based on workload deployment name and/or a container image name.

Cloud management code 104 can be further configurated to generate temporal activity signatures 110 for one or more representations 142 of the entity representations from aggregated data 106. The temporal activity signatures 110 can be vectors of positional encodings of read/write interactions of one entity with other entities in the cloud environment 120. The temporal activity signatures 110 can be input to a trained LSTM network model 112, where the trained LSTM network model 112 generates a prediction of whether each temporal activity signature 110 belongs to one of multiple classes (with each class representing an entity). For temporal activity signatures 110 determined to belong to a same class, the underlying representations 142 of those temporal activity signatures 110 can be unified. In some embodiments, temporal activity signatures 110 are only generated for representations 142 with an attribute signature 108 that does not match any other attribute signature 108 of any other representation 142. In this way, the relatively more computationally expensive LSTM technique is only used for representations 142 that cannot be unified using the relatively less computationally expensive attribute signatures 108.

Unified entity representations from aggregated data 114 can be a coalesced version of the initially received entity representations from aggregated data 106. More specifically, unified entity representations from aggregated data 114 can unify those entities that either (i) exhibit sufficiently similar attribute signatures 108, and/or (ii) are predicted to belong to a same class when the underlying temporal activity signatures 110 are provided to the trained LSTM network model 112. For example, the first representation 142-1 and the second representation 142-2 can be coalesced into a first unified representation 144-1. As an example, first representation 142-1 and second representation 142-2 can be coalesced based on the first representation 142-1 and the second representation 142-2 having similar or identical attribute signatures 108. As another example, third representation 142-3 and fourth representation 142-4 can be coalesced into a second unified representation 144-2. In this example, the third representation 142-3 and the fourth representation 142-4 can have different attribute signatures 108 but nonetheless represent the same entity. To resolve this, the third representation 142-3 and the fourth representation 142-4 can be coalesced based on the LSTM network model 112 generating a prediction that the third representation 142-3 and the fourth representation 142-4 belong to a same class with a confidence above a threshold based on temporal activity signatures 110 of the third representation 142-3 and the fourth representation 142-4.

Cloud management code 104 can be further configured to generate a knowledge graph 116 using the unified entity representations from aggregated data 114 (e.g., unified representations 144). Knowledge graph 116 can represent entities and relationships between entities in cloud environment 120. Knowledge graph 116 can be used to ensure compliance with various security paradigms (e.g., Zero Trust) and/or Service Level Agreements (SLAs). Knowledge graph 116 can be, for example, an ontology of the cloud environment 120, a schema of the cloud environment 120, and/or a cloud environment graph of the cloud environment 120. Advantageously, knowledge graph 116 is relatively more accurate than traditional knowledge graphs insofar as duplicative representations of a same entity are coalesced into a single representation. In this way, knowledge graph 116 provides a holistic view of data from cybersecurity tools 128 for respective entities in the cloud environment 120.

Cloud management code 104 can be further configured to utilize policy compliance and auditing tools 118 to implement, audit, and/or confirm compliance with various policies related to legal regulations, best practices, contractual obligations, and the like. Policy compliance and auditing tools 118 can utilize the knowledge graph 116 to perform its functions.

FIG. 1 is for illustrative purposes and should not be construed as limiting. More, fewer, and/or different components than the components illustrated in FIG. 1 can be present while remaining within the spirit and scope of the present disclosure. Further, illustrated components can be separated into multiple, discrete components, and/or multiple discrete components can be combined into a single component, while remaining within the spirit and scope of the present disclosure.

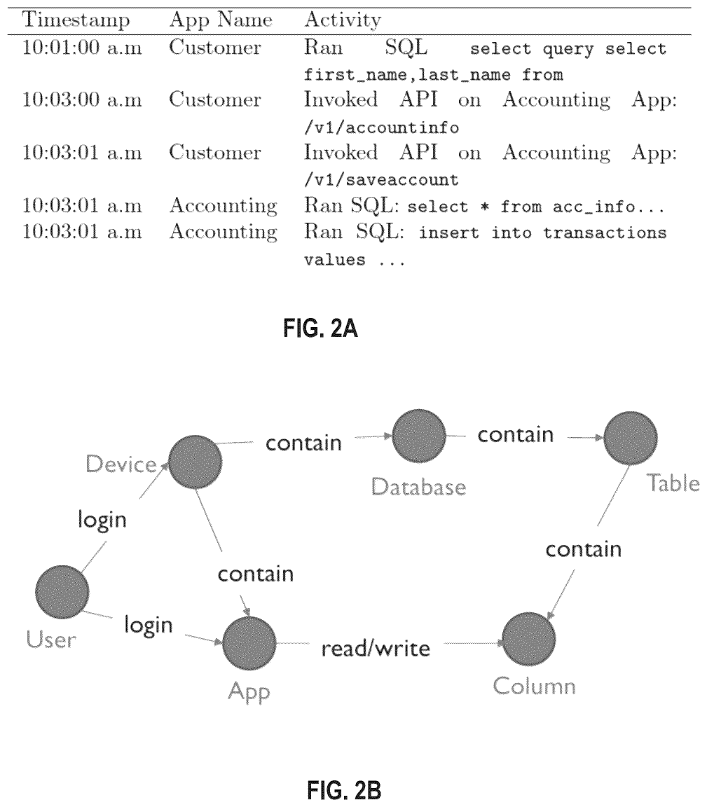

FIG. 2A illustrates an example data feed of an application in a cloud environment, in accordance with embodiments of the present disclosure. More specifically, FIG. 2A illustrates a web application issuing periodic SQL queries to a backend data store. The columns in FIG. 2A show the timestamp of activity, name of the application performing the action, and the details of the action. The data feed in FIG. 2A can be logged by one or more cybersecurity tools (e.g., cybersecurity tools 128 of FIG. 1).

FIG. 2B illustrates a block diagram of a cloud environment graph generated from numerous data feeds (e.g., such as the data feed illustrated in FIG. 2A), in accordance with embodiments of the present disclosure. In some embodiments, FIG. 2B is consistent with knowledge graph 116 of FIG. 1.

Knowledge graphs, such as the knowledge graph in FIG. 2B can be leveraged to implement systems that comply with, and/or provide proof of compliance with: best practices, legal regulations, industry standards, and/or contractual obligations (e.g., SLAs). In FIG. 2B, an “App” can refer to an application entity. A “device” can refer to a container, pod, deployment, and/or Virtual Machine (VM) that hosts the application. A “user” can refer to an end user of the application. A “database” can refer to a data store (e.g., MySQL, Postgres, etc.). A “table” can refer to a database table, and a “column” can refer to a database column. The term “connect” (not explicitly shown in FIG. 2B) can refer to an API call or connection made between two entities (e.g., invoking an API, connecting a database, etc.). The term “contain” can refer to a hierarchical or dependent-type relation such as a column belonging to a table, an application implemented on a virtual machine, and the like. The term “login” can refer to an access command (e.g., a user logging into an application). The term “read/write” can refer to a data implementation command such as viewing (e.g., reading), modifying (e.g., writing), and the like.

In the example cloud environment graph illustrated in FIG. 2B, a node can represent an entity (e.g., asset) in the cloud environment. The node can represent various types of entities at various levels of granularity such as an application, a device, a VM, a database, tables, columns, etc. An edge can represent specific interactions or relations between nodes. For example, a user logging into an application can form an edge. As another example, an application reading a column in a database can form an edge. Furthermore, all nodes that are one edge away from a given node can be considered immediate neighbors of the given node. Further still, a dictionary (not shown) can store unique integer values and/or positions associated with each type of interaction in the graph. The cloud environment graph and/or the dictionary can be used to generate features. A feature can be an n-dimensional vector representing the interaction of a given node with its neighbors.

As an example of the correspondence between FIGS. 2A and 2B, an action such as “Ran SQL: ‘select * from acc_info’ by Accounting App” can create an edge from an entity (e.g., node) representing “Accounting App” to the entities representing all the columns in an “acc_info” table.

However, as recognized by aspects of the present disclosure, aggregating many data feeds from many tools operating in a cloud environment can result in duplicative representations of the same entity by the different tools. Consequently, cloud environment graphs generated from data having duplicative representations of the same entity will result in a representation that is unwieldy, inaccurate, and seldom useful. Advantageously, aspects of the present disclosure unify duplicative representations of the same entity in the data feeds of different tools, thereby creating a coherent, accurate, and useful cloud environment graph that can be reliably used to implement, comply with, and/or provide proof of compliance with: best practices, legal regulations, industry standards, and/or contractual obligations (e.g., SLAs).

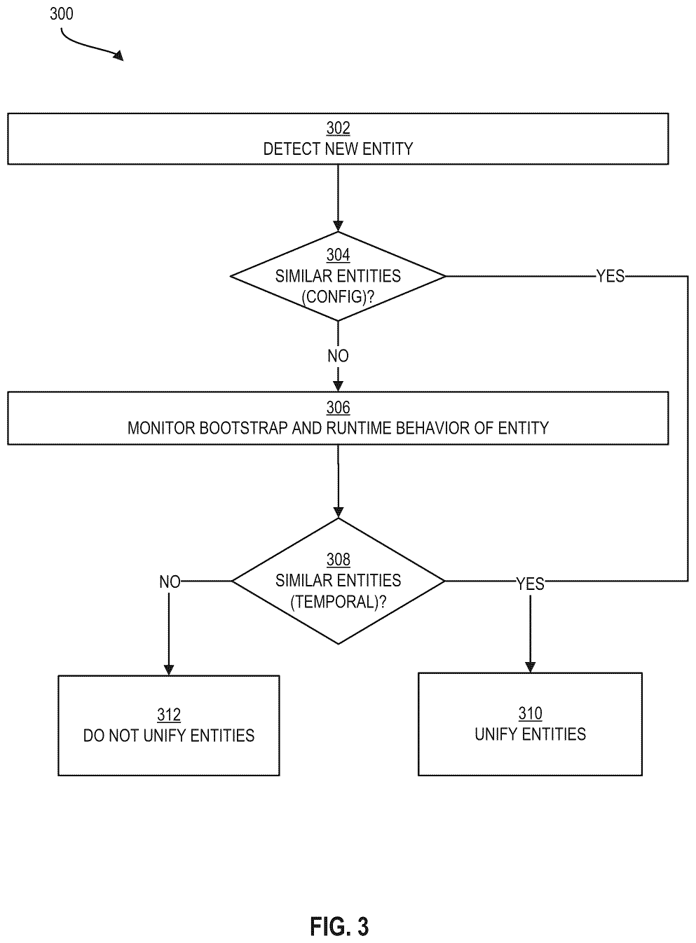

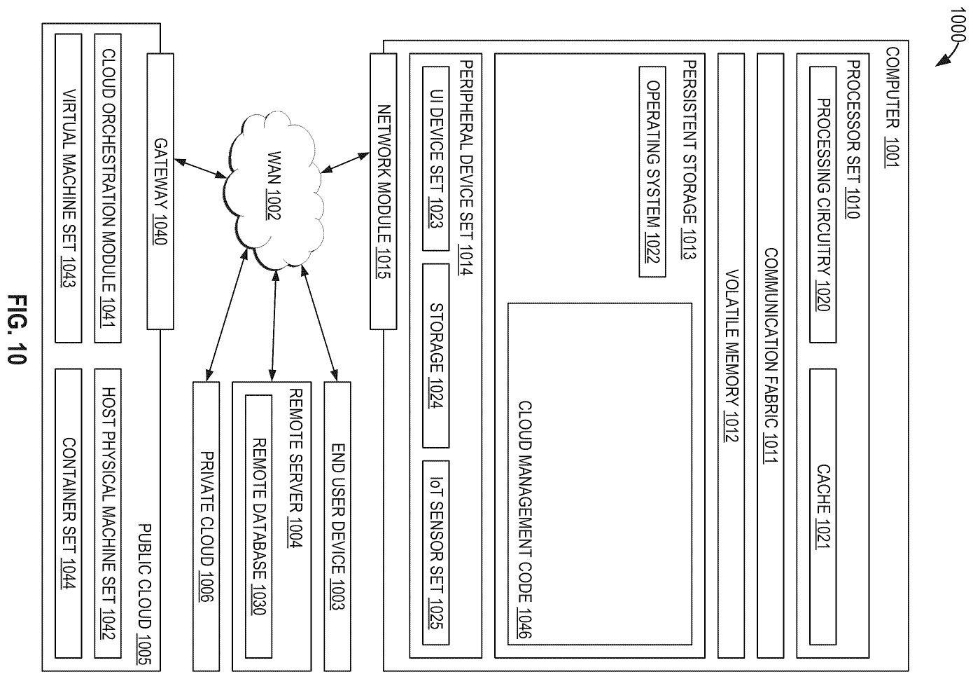

FIG. 3 illustrates a flowchart of an example method 300 for unifying multiple discrete representations of a same entity in a cloud environment graph, in accordance with embodiments of the present disclosure. The method 300 can be implemented by, for example, a server (e.g., server 102 of FIG. 1), a computer (e.g., computer 1001 of FIG. 10), a processor, and/or another configuration of hardware and/or software.

Operation 302 includes detecting a new entity. The new entity can be, for example, an application executing in a cloud environment, where the application is detected by one or more cybersecurity tools.

Operation 304 includes determining whether the new entity is similar to another entity based on configuration attributes. In some embodiments, operation 304 determines whether a workload deployment name and/or container image name of the newly detected entity matches the workload deployment name and/or container image name of any pre-existing entity of the cloud environment. Advantageously, operation 304 provides an initial, low-cost matching algorithm to unify some duplicative representations of the same entity, thereby reducing the number of detected entities passed to the relatively more computationally expensive LSTM network model algorithm described below with respect to operation 308.

If so (304: YES), then the method 300 proceeds to operation 310 and unifies the entities by combining the detected new entity with another pre-existing entity that is determined to be the same (based on matching configuration attributes). In other words, operation 310 can combine a data feed from the detected new entity with data feed(s) of the matching pre-existing entity in a cloud environment graph. If not (304: NO), then the method 300 proceeds to operation 306.

Operation 306 includes monitoring bootstrap and/or runtime behavior of the detected new entity. In some embodiments, operation 306 generates a temporal activity signature (e.g., temporal activity signature 110 of FIG. 1) associated with the detected new entity.

Operation 308 includes determining whether the detected new entity is similar to another entity based on temporal features. In some embodiments, operation 308 utilizes a LSTM network model (e.g., LSTM network model 112 of FIG. 1) to determine whether the detected new entity is the same as a pre-existing entity based on whether a temporal activity signature of the detected new entity is associated with a class of the multi-class LSTM network model above a threshold probability or confidence. Advantageously, operation 308 can detect duplicative representations of a same entity even if the duplicative representations have different configuration attributes.

If so (308: YES), then the method 300 proceeds to operation 310 and unifies the newly detected entity with one or more pre-existing entities in the class indicated by the LSTM network model. In other words, operation 310 can combine a data feed from the detected new entity with data feeds of the one or more pre-existing entities in a cloud environment graph. If not (308: NO), then the method 300 proceeds to operation 312 and does not unify the newly detected entity with any pre-existing entity. In other words, operation 312 can create a new node for the detected new entity in a cloud environment graph.

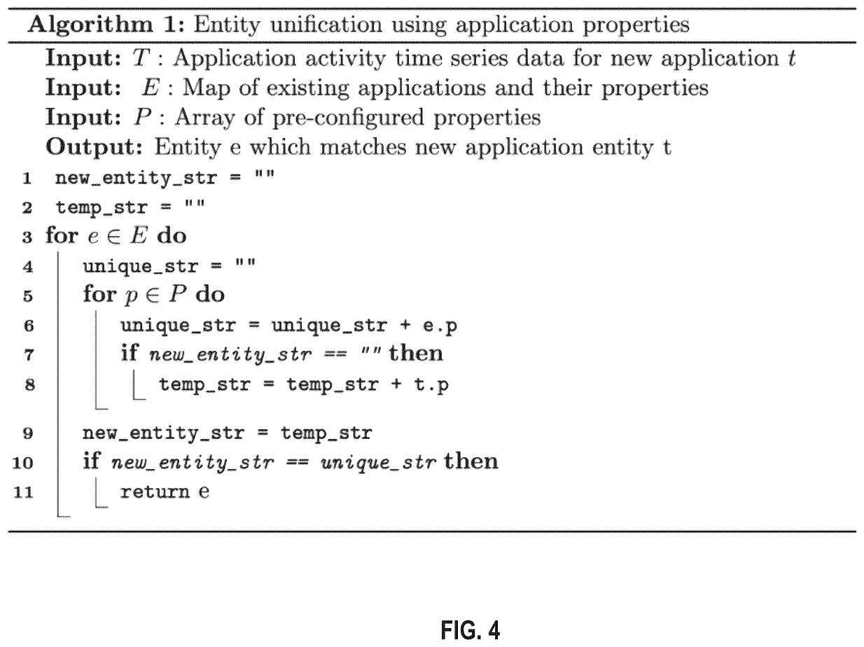

FIG. 4 illustrates example computer code for identifying multiple representations of a same entity using attributes, in accordance with some embodiments of the present disclosure. The example computer code illustrated in FIG. 4 can be utilized by, for example, operation 304 of FIG. 3 to determine whether a newly detected entity shares configuration attributes (e.g., workload deployment name, container image name, etc.) with another pre-existing entity in order to unify duplicative representations of a same entity. In some embodiments, the example computer code illustrated in FIG. 4 can utilize attribute signatures (e.g., attribute signatures 108 of FIG. 1) to identify duplicative representations of the same entity.

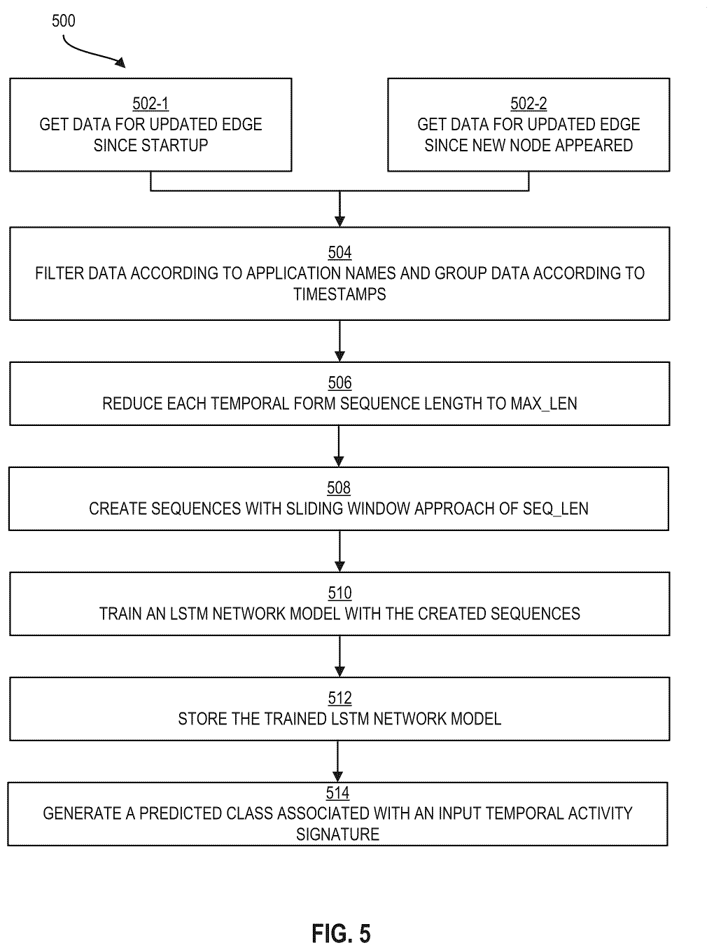

FIG. 5 illustrates a flowchart of an example method for identifying multiple representations of a same entity using a Long-Short Term Memory (LSTM) network, in accordance with some embodiments of the present disclosure. The method 500 can be implemented by, for example, a server (e.g., server 102 of FIG. 1), a computer (e.g., computer 1001 of FIG. 10), a processor, and/or another configuration of hardware and/or software. In some embodiments, the method 500 is a sub-method of operation 308 of FIG. 3.

Operation 502-1 includes getting data for an updated edge since startup. In contrast, operation 502-2 includes getting data for an updated edge since a new node appeared. In other words, operation 502-1 can initiate the method 500 for purposes of training the LSTM network model and generating an inference from the trained LSTM network model, whereas operation 502-2 can initiate the method 500 for purposes of re-training an existing trained LSTM network model and generating an inference from the re-trained LSTM network model.

Operation 504 includes filtering data according to application names and grouping data according to timestamps. In other words, operation 504 can generate temporal form sequences that can be further refined into temporal activity signatures (e.g., temporal activity signatures 110 of FIG. 1).

Operation 506 includes reducing each temporal form sequence to a predetermined length (e.g., MAX_LEN). Operation 508 includes creating temporal form sequences using a sliding window with a predetermined window size (e.g., SEQ_LEN). Operation 510 includes training an LSTM network model with the sequences created in operation 508. In some embodiments, operation 510 utilizes supervised classification, whereas in other embodiments, operation 510 can utilize semi-supervised or unsupervised classification during training.

Operation 512 includes storing the trained LSTM network model. For example, the trained LSTM network model can be stored in a server (e.g., trained LSTM network model 112 stored in server 102 of FIG. 1).

Operation 514 includes generating a predicted class associated with an input temporal activity signature. If the probability or confidence of the predicted class exceeds a threshold (e.g., 90%, 95%, 99%, etc.), then the entity associated with the input temporal activity signature can be unified with the one or more entities associated with the predicted class.

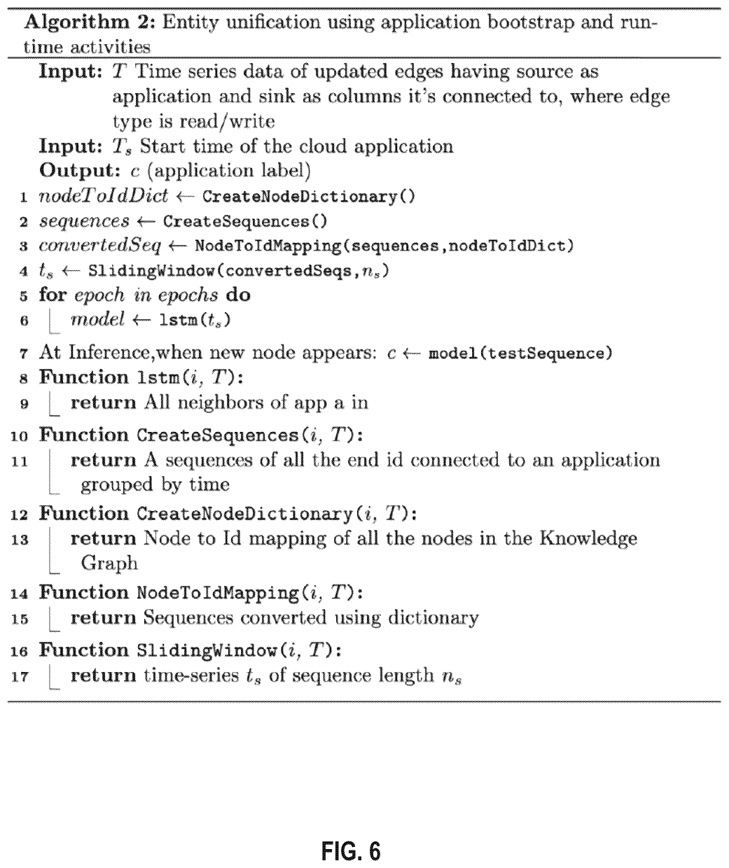

FIG. 6 illustrates example computer code for identifying multiple representations of a same entity using the LSTM network, in accordance with some embodiments of the present disclosure. In some embodiments, the example computer code can implement operations 308 of FIG. 3 and/or the method 500 of FIG. 5.

First, regarding input, the activities of an application (e.g., entity) are periodically provided to a time-series database. The activities include, for example, read/write interactions between an application and tables/columns. Second, a dictionary including all unique nodes, N, in the cloud environment graph is created (e.g., code line 1 of FIG. 6). The size of the dictionary can be 2*N (based on positional encoding of read/write nodes). For example, for a graph having two nodes (e.g., app1 and app2), the dictionary can create {read_app1:0, write_app1:1, read_app2:2, write_app2:3, misc: 4}. Using the created dictionary, a vector for each timestamp can be created using the positional encoding (e.g., code lines 2-3 of FIG. 6). Continuing the above example, app1 connected to app2 by a read edge at a given timestamp can be recorded as [2].

The generated vectors can be converted to a consistent size (e.g., length L) by padding with a default encoding (e.g., misc: 4), thereby creating vectors of length seq_len (e.g., code line 4 of FIG. 6). In some embodiments, a sliding window approach is used. The generated vectors (e.g., temporal activity signatures 110 of FIG. 1) can then be fed to a LSTM network model (e.g., code line 5 of FIG. 6). The LSTM network model can receive the generated vectors as input and provide as output a probability of the input vector belonging to each class (where each class represents a pre-existing entity in the cloud environment graph, with some classes having multiple representations of a same entity unified therein). In some embodiments, the

LSTM network model can be trained by training data containing an activity profile of each application/entity of a cloud environment. In the interest of usability, in some embodiments, the LSTM network model can be compressed and stored in the cloud.

When a new application entity appears (e.g., code line 7 of FIG. 6), the runtime behavior of the application can be logged for a predetermined time t. The logged runtime behavior can then be featurized (e.g., code lines 1-4 of FIG. 6) and provided to the trained LSTM network model. The trained LSTM network model ingests the featurized vector of the new application entity and generates a probability of the new application entity belonging to one of the classes in the trained LSTM network model. If the probability exceeds a confidence threshold, then the new application entity can be unified with the one or more entities represented by the highest-confidence predicted class.

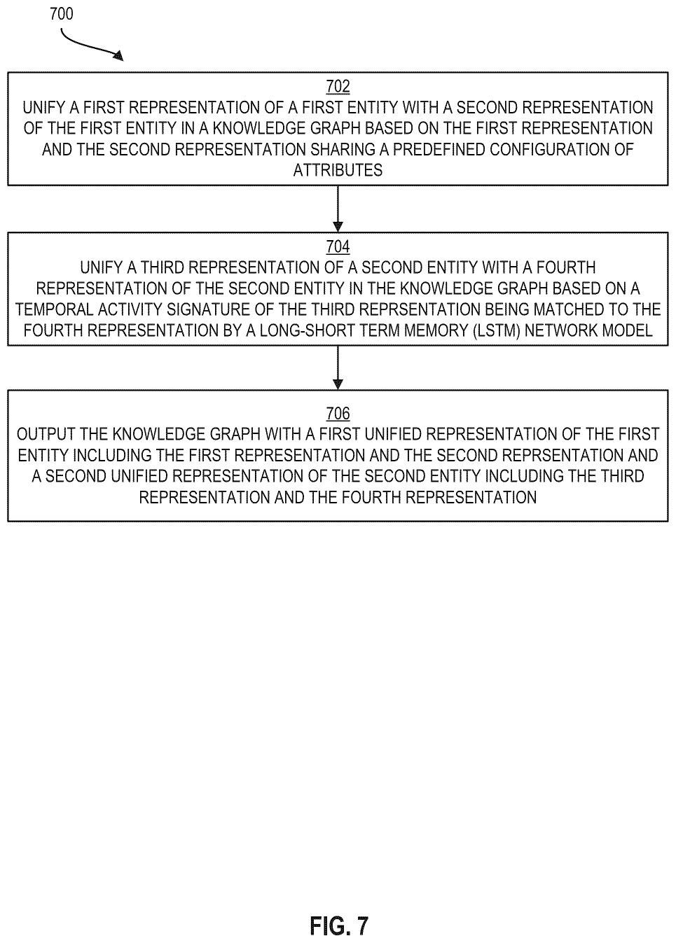

FIG. 7 illustrates a flowchart of another example method 700 for unifying multiple discrete representations of a same entity in a cloud environment graph, in accordance with some embodiments of the present disclosure. The method 700 can be implemented by, for example, a server (e.g., server 102 of FIG. 1), a computer (e.g., computer 1001 of FIG. 10), a processor, and/or another configuration of hardware and/or software.

Operation 702 includes unifying a first representation of a first entity with a second representation of the first entity in a knowledge graph based on the first representation and the second representation sharing a predefined configuration of attributes. In some embodiments, the first entity and the second entity are applications implemented in a cloud environment. In some embodiments, the first entity and the second entity are microservices implemented in a cloud environment. In some embodiments, the predefined configuration of attributes includes a workload deployment name and/or a container image name. The respective representations of the respective entities can be generated by different cybersecurity tools. In some embodiments, the knowledge graph can refer to a schema, ontology, or graph of a cloud environment.

Operation 704 includes unifying a third representation of a second entity with a fourth representation of the second entity in the knowledge graph based on a temporal activity signature of the third representation being matched to the fourth representation by a LSTM network model. In some embodiments, the third representation and the fourth representation can be associated with different IP addresses, different hostnames, and/or different instances of a same application implemented in different clusters of a cloud environment. In some embodiments, the third representations and the fourth representation do not have similar or matching configuration attributes.

Operation 706 includes outputting the knowledge graph with a first unified representation of the first entity including the first representation and the second representation and a second unified representation of the second entity including the third representation and the fourth representation. Advantageously, in some embodiments, operations 702, 704, and 706 occur without accessing and/or modifying entity binaries (e.g., application binaries) and/or entity source code (e.g., application source code).

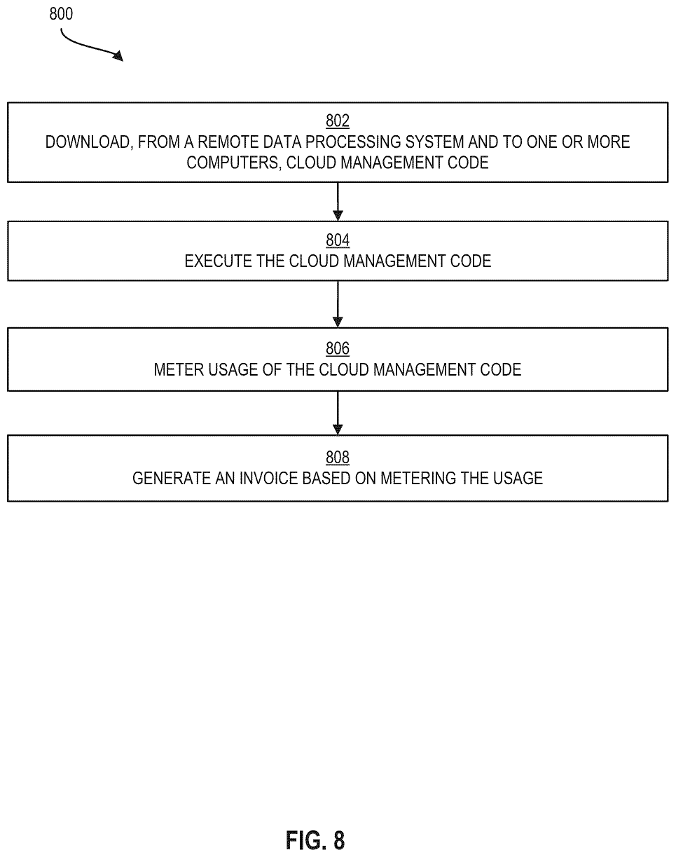

FIG. 8 illustrates a flowchart of an example method 800 for downloading, deploying, metering, and billing usage of cloud management code, in accordance with some embodiments of the present disclosure. The method 800 can be implemented by, for example, a server (e.g., server 102 of FIG. 1), a computer (e.g., computer 1001 of FIG. 10), a processor, and/or another configuration of hardware and/or software. In some embodiments, the method 800 occurs concurrently with one or more operations of the method 700 of FIG. 7.

Operation 802 includes downloading, from a remote data processing system and to one or more computers (e.g., server 102) cloud management code (e.g., cloud management code 104 of FIG. 1, cloud management code 1046 of FIG. 10). Operation 804 includes executing the cloud management code. Operation 804 can include performing any of the methods and/or functionalities discussed herein. Operation 806 includes metering usage of the cloud management code. Usage can be metered by, for example, an amount of time the cloud management code is used, a number of servers and/or devices deploying the cloud management code, an amount of resources consumed by implementing the cloud management code, a number entities unified and/or unified knowledge graphs generated by implementing the cloud management code, and/or other usage metering metrics. Operation 808 includes generating an invoice based on metering the usage.

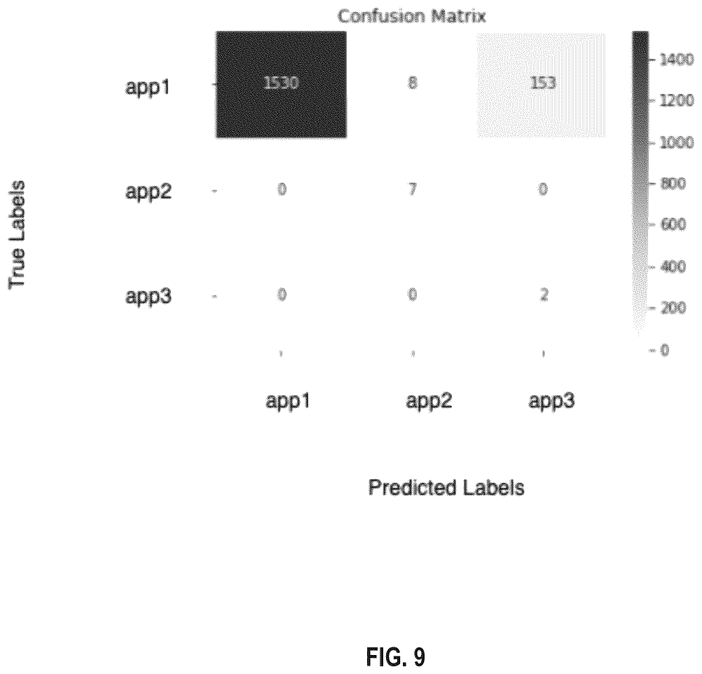

FIG. 9 illustrates a diagram of experimental results obtained by implementing cloud management code, in accordance with some embodiments of the present disclosure. The experimental results were obtained by executing the cloud management code in a test cloud environment having three applications (e.g., app1, app2, and app3). The LSTM network model was trained as a three-class classifier. Furthermore, a “true positive rate” was calculated for new nodes appearing in the test cloud environment and belonging to one of the three classes (e.g., app1, app2, or app3). The training data for the LSTM network model utilized 349 samples from each class. FIG. 9 exhibits a confusion matrix of the experimental results, where the confusion matrix compares predicted labels (x-axis) to true labels (y-axis). Collectively, the experimental results included: True Positive Rate: [0.90479007, 1, 1]; False Positive Rate: [0, 0.00472534, 0.09010601]; and Accuracy: [0.90529412, 0.99529412, 0.91]. As shown above, the high true positive rate, low false positive rate, and high accuracy indicate that aspects of the present disclosure accurately and effectively unify duplicative representations of a same entity in a cloud environment. Furthermore, while not explicitly shown by the experimental results in FIG. 10, aspects of the present disclosure achieve the aforementioned effective and accurate results with computational efficiency (e.g., due to the two-part identification of duplicative entities—first by matching configuration attributes and subsequently, if needed, by the LSTM network model using temporal activity signatures).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

FIG. 10 illustrates a block diagram of an example computing environment, in accordance with some embodiments of the present disclosure. Computing environment 1000 contains an example of an environment for the execution of at least some of the computer code involved in performing the inventive methods, such as cloud management code 1046. In addition to cloud management code 1046, computing environment 1000 includes, for example, computer 1001, wide area network (WAN) 1002, end user device (EUD) 1003, remote server 1004, public cloud 1005, and private cloud 1006. In this embodiment, computer 1001 includes processor set 1010 (including processing circuitry 1020 and cache 1021), communication fabric 1011, volatile memory 1012, persistent storage 1013 (including operating system 1022 and cloud management code 1046, as identified above), peripheral device set 1014 (including user interface (UI), device set 1023, storage 1024, and Internet of Things (IoT) sensor set 1025), and network module 1015. Remote server 1004 includes remote database 1030. Public cloud 1005 includes gateway 1040, cloud orchestration module 1041, host physical machine set 1042, virtual machine set 1043, and container set 1044.

COMPUTER 1001 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1030. As is well understood in the art of computer technology, and depending upon the technology, performance of a computer-implemented method may be distributed among multiple computers and/or between multiple locations. On the other hand, in this presentation of computing environment 1000, detailed discussion is focused on a single computer, specifically computer 1001, to keep the presentation as simple as possible. Computer 1001 maybe located in a cloud, even though it is not shown in a cloud in FIG. 10. On the other hand, computer 1001 is not required to be in a cloud except to any extent as may be affirmatively indicated.

PROCESSOR SET 1010 includes one, or more, computer processors of any type now known or to be developed in the future. Processing circuitry 1020 maybe distributed over multiple packages, for example, multiple, coordinated integrated circuit chips. Processing circuitry 1020 may implement multiple processor threads and/or multiple processor cores. Cache 1021 is memory that is located in the processor chip package(s) and is typically used for data or code that should be available for rapid access by the threads or cores running on processor set 1010. Cache memories are typically organized into multiple levels depending upon relative proximity to the processing circuitry. Alternatively, some, or all, of the cache for the processor set may be located “off chip.” In some computing environments, processor set 1010 maybe designed for working with qubits and performing quantum computing.

Computer readable program instructions are typically loaded onto computer 1001 to cause a series of operational steps to be performed by processor set 1010 of computer 1001 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 1021 and the other storage media discussed below. The program instructions, and associated data, are accessed by processor set 1010 to control and direct performance of the inventive methods. In computing environment 1000, at least some of the instructions for performing the inventive methods may be stored in cloud management code 1046 in persistent storage 1013.

COMMUNICATION FABRIC 1011 is the signal conduction paths that allow the various components of computer 1001 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1012 is any type of volatile memory now known or to be developed in the future. Examples include dynamic type random access memory (RAM) or static type RAM. Typically, the volatile memory is characterized by random access, but this is not required unless affirmatively indicated. In computer 1001, the volatile memory 1012 is located in a single package and is internal to computer 1001, but, alternatively or additionally, the volatile memory may be distributed over multiple packages and/or located externally with respect to computer 1001.

PERSISTENT STORAGE 1013 is any form of non-volatile storage for computers that is now known or to be developed in the future. The non-volatility of this storage means that the stored data is maintained regardless of whether power is being supplied to computer 1001 and/or directly to persistent storage 1013. Persistent storage 1013 maybe a read only memory

(ROM), but typically at least a portion of the persistent storage allows writing of data, deletion of data and re-writing of data. Some familiar forms of persistent storage include magnetic disks and solid state storage devices. Operating system 1022 may take several forms, such as various known proprietary operating systems or open source Portable Operating System Interface type operating systems that employ a kernel. The code included in cloud management code 1046 typically includes at least some of the computer code involved in performing the inventive methods.

PERIPHERAL DEVICE SET 1014 includes the set of peripheral devices of computer 1001. Data communication connections between the peripheral devices and the other components of computer 1001 maybe implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 1023 may include components such as a display screen, speaker, microphone, wearable devices (such as goggles and smart watches), keyboard, mouse, printer, touchpad, game controllers, and haptic devices. Storage 1024 is external storage, such as an external hard drive, or insertable storage, such as an SD card. Storage 1024 maybe persistent and/or volatile. In some embodiments, storage 1024 may take the form of a quantum computing storage device for storing data in the form of qubits. In embodiments where computer 1001 is required to have a large amount of storage (for example, where computer 1001 locally stores and manages a large database) then this storage may be provided by peripheral storage devices designed for storing very large amounts of data, such as a storage area network (SAN) that is shared by multiple, geographically distributed computers. IoT sensor set 1025 is made up of sensors that can be used in Internet of Things applications. For example, one sensor may be a thermometer and another sensor may be a motion detector.

NETWORK MODULE 1015 is the collection of computer software, hardware, and firmware that allows computer 1001 to communicate with other computers through WAN 1002. Network module 1015 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1015 are performed on the same physical hardware device. In other embodiments (for example, embodiments that utilize software-defined networking (SDN)), the control functions and the forwarding functions of network module 1015 are performed on physically separate devices, such that the control functions manage several different network hardware devices. Computer readable program instructions for performing the inventive methods can typically be downloaded to computer 1001 from an external computer or external storage device through a network adapter card or network interface included in network module 1015.

WAN 1002 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1003 is any computer system that is used and controlled by an end user (for example, a customer of an enterprise that operates computer 1001), and may take any of the forms discussed above in connection with computer 1001. EUD 1003 typically receives helpful and useful data from the operations of computer 1001. For example, in a hypothetical case where computer 1001 is designed to provide a recommendation to an end user, this recommendation would typically be communicated from network module 1015 of computer 1001 through WAN 1002 to EUD 1003. In this way, EUD 1003 can display, or otherwise present, the recommendation to an end user. In some embodiments, EUD 1003 maybe a client device, such as thin client, heavy client, mainframe computer, desktop computer and so on.

REMOTE SERVER 1004 is any computer system that serves at least some data and/or functionality to computer 1001. Remote server 1004 maybe controlled and used by the same entity that operates computer 1001. Remote server 1004 represents the machine(s) that collect and store helpful and useful data for use by other computers, such as computer 1001. For example, in a hypothetical case where computer 1001 is designed and programmed to provide a recommendation based on historical data, then this historical data may be provided to computer 1001 from remote database 1030 of remote server 1004.

PUBLIC CLOUD 1005 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1005 is performed by the computer hardware and/or software of cloud orchestration module 1041. The computing resources provided by public cloud 1005 are typically implemented by virtual computing environments that run on various computers making up the computers of host physical machine set 1042, which is the universe of physical computers in and/or available to public cloud 1005. The virtual computing environments (VCEs) typically take the form of virtual machines from virtual machine set 1043 and/or containers from container set 1044. It is understood that these VCEs may be stored as images and may be transferred among and between the various physical machine hosts, either as images or after instantiation of the VCE. Cloud orchestration module 1041 manages the transfer and storage of images, deploys new instantiations of VCEs and manages active instantiations of VCE deployments. Gateway 1040 is the collection of computer software, hardware, and firmware that allows public cloud 1005 to communicate through WAN 1002.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1006 is similar to public cloud 1005, except that the computing resources are only available for use by a single enterprise. While private cloud 1006 is depicted as being in communication with WAN 1002, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1005 and private cloud 1006 are both part of a larger hybrid cloud.

The flowchart and block diagrams in the Figures illustrate the architecture, functionality, and operation of possible implementations of systems, methods, and computer program products according to various embodiments of the present invention. In this regard, each block in the flowchart or block diagrams can represent a module, segment, or subset of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the process software (e.g., any software configured to perform any portion of the methods described previously and/or implement any of the functionalities described previously) can be deployed by manually loading it directly in the client, server, and proxy computers via loading a storage medium such as a CD, DVD, etc., the process software can also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Embodiments of the present invention can also be delivered as part of a service engagement with a client corporation, nonprofit organization, government entity, internal organizational structure, or the like. These embodiments can include configuring a computer system to perform, and deploying software, hardware, and web services that implement, some or all of the methods described herein. These embodiments can also include analyzing the client's operations, creating recommendations responsive to the analysis, building systems that implement subsets of the recommendations, integrating the systems into existing processes and infrastructure, metering use of the systems, allocating expenses to users of the systems, and billing, invoicing (e.g., generating an invoice), or otherwise receiving payment for use of the systems.

The terminology used herein is for the purpose of describing particular embodiments only and is not intended to be limiting of the various embodiments. As used herein, the singular forms “a,” “an,” and “the” are intended to include the plural forms as well, unless the context clearly indicates otherwise. It will be further understood that the terms “includes” and/or “including,” when used in this specification, specify the presence of the stated features, integers, steps, operations, elements, and/or components, but do not preclude the presence or addition of one or more other features, integers, steps, operations, elements, components, and/or groups thereof. In the previous detailed description of example embodiments of the various embodiments, reference was made to the accompanying drawings (where like numbers represent like elements), which form a part hereof, and in which is shown by way of illustration specific example embodiments in which the various embodiments can be practiced. These embodiments were described in sufficient detail to enable those skilled in the art to practice the embodiments, but other embodiments can be used and logical, mechanical, electrical, and other changes can be made without departing from the scope of the various embodiments. In the previous description, numerous specific details were set forth to provide a thorough understanding of the various embodiments. But the various embodiments can be practiced without these specific details. In other instances, well-known circuits, structures, and techniques have not been shown in detail in order not to obscure embodiments.

Different instances of the word “embodiment” as used within this specification do not necessarily refer to the same embodiment, but they can. Any data and data structures illustrated or described herein are examples only, and in other embodiments, different amounts of data, types of data, fields, numbers and types of fields, field names, numbers and types of rows, records, entries, or organizations of data can be used. In addition, any data can be combined with logic, so that a separate data structure may not be necessary. The previous detailed description is, therefore, not to be taken in a limiting sense.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the disclosure.

Any advantages discussed in the present disclosure are example advantages, and embodiments of the present disclosure can exist that realize all, some, or none of any of the discussed advantages while remaining within the spirit and scope of the present disclosure.

A non-limiting list of examples are provided hereinafter to demonstrate some aspects of the present disclosure. Example 1 is a computer-implemented method. The method includes unifying a first representation of a first entity with a second representation of the first entity in a knowledge graph of a cloud environment based on the first representation and the second representation sharing a predefined configuration of attributes; unifying a third representation of a second entity with a fourth representation of the second entity in the knowledge graph based on a temporal activity signature of the third representation being matched to the fourth representation by a Long-Short Term Memory (LSTM) network model; and outputting the knowledge graph with a first unified representation of the first entity based on the first representation and the second representation and a second unified representation of the second entity based on the third representation and the fourth representation.

Example 2 includes the features of Example 1. In this example, the first entity and the second entity are applications in the cloud environment. Optionally the applications are microservices deployed in one or more clusters of the cloud environment.

Example 3 includes the features of any one of Examples 1 or 2, including or excluding optional features. In this example, the predefined configuration of attributes comprises a workload deployment name and a container image name.

Example 4 includes the features of any one of Examples 1 to 3, including or excluding optional features. In this example, respective representations of respective entities are generated by different cybersecurity tools implemented in the cloud environment.

Example 5 includes the features of any one of Examples 1 to 4, including or excluding optional features. In this example, the method is performed without accessing application binaries.

Example 6 includes the features of any one of Examples 1 to 5, including or excluding optional features. In this example, the method is performed without accessing application source code.

Example 7 includes the features of any one of Examples 1 to 6, including or excluding optional features. In this example, the third representation of the second entity and the fourth representation of the second entity are associated with different Internet Protocol (IP) addresses.

Example 8 includes the features of any one of Examples 1 to 7, including or excluding optional features. In this example, the third representation of the second entity and the fourth representation of the second entity are associated with different hostnames.

Example 9 includes the features of any one of Examples 1 to 8, including or excluding optional features. In this example, the third representation of the second entity and the fourth representation of the second entity are discrete implementations of the second entity in different distributed computing environments.

Example 10 includes the features of any one of Examples 1 to 9, including or excluding optional features. In this example, the knowledge graph of the cloud environment is one or more selected from a group consisting of: an ontology of the cloud environment, a schema of the cloud environment, and a graph of the cloud environment.

Example 11 includes the features of any one of Examples 1 to 10, including or excluding optional features. In this example, the method is performed by a server implementing cloud management code. Optionally, the method further comprises: metering usage of the cloud management code; and generating an invoice based on metering the usage of the cloud management code.

Example 12 is a system. The system includes one or more computer readable storage media storing program instructions; and one or more processors which, in response to executing the program instructions, are configured to perform a method according to any one of Examples 1 to 11, including or excluding optional features.

Example 13 is a computer program product. The computer program product includes one or more computer readable storage media, and program instructions collectively stored on the one or more computer readable storage media, the program instructions comprising instructions configured to cause one or more processors to perform a method according to any one of Examples 1 to 11, including or excluding optional features.

What is claimed is:

1. A method comprising:
unifying a first representation of a first entity with a second representation of the first entity in a knowledge graph of a cloud environment based on the first representation and the second representation sharing a predefined configuration of attributes;
unifying a third representation of a second entity with a fourth representation of the second entity in the knowledge graph based on a temporal activity signature of the third representation being matched to the fourth representation by a Long-Short Term Memory (LSTM) network model; and
outputting the knowledge graph with a first unified representation of the first entity based on the first representation and the second representation and a second unified representation of the second entity based on the third representation and the fourth representation.

2. The method of claim 1, wherein the first entity and the second entity are applications in the cloud environment.

3. The method of claim 2, wherein the applications are microservices deployed in one or more clusters of the cloud environment.

4. The method of claim 1, wherein the predefined configuration of attributes comprises a workload deployment name and a container image name.

5. The method of claim 1, wherein respective representations of respective entities are generated by different cybersecurity tools implemented in the cloud environment.

6. The method of claim 1, wherein the method is performed without accessing application binaries.

7. The method of claim 1, wherein the method is performed without accessing application source code.

8. The method of claim 1, wherein the third representation of the second entity and the fourth representation of the second entity are associated with different Internet Protocol (IP) addresses.

9. The method of claim 1, wherein the third representation of the second entity and the fourth representation of the second entity are associated with different hostnames.

10. The method of claim 1, wherein the third representation of the second entity and the fourth representation of the second entity are discrete implementations of the second entity in different distributed computing environments.

11. The method of claim 1, wherein the knowledge graph of the cloud environment is one or more selected from a group consisting of: an ontology of the cloud environment, a schema of the cloud environment, and a graph of the cloud environment.

12. The method of claim 1, wherein the method is performed by a server implementing cloud management code, and wherein the method further comprises:
metering usage of the cloud management code; and
generating an invoice based on metering the usage of the cloud management code.

13. A system comprising:
one or more computer readable storage media storing program instructions; and
one or more processors which, in response to executing the program instructions, are configured to perform a method comprising:
unifying a first representation of a first entity with a second representation of the first entity in a knowledge graph of a cloud environment based on the first representation and the second representation sharing a predefined configuration of attributes;
unifying a third representation of a second entity with a fourth representation of the second entity in the knowledge graph based on a temporal activity signature of the third representation being matched to the fourth representation by a Long-Short Term Memory (LSTM) network model; and
outputting the knowledge graph with a first unified representation of the first entity based on the first representation and the second representation and a second unified representation of the second entity based on the third representation and the fourth representation.

14. The system of claim 13, wherein the first entity and the second entity are applications in the cloud environment.

15. The system of claim 13, wherein the predefined configuration of attributes comprises a workload deployment name and a container image name.

16. The system of claim 13, wherein respective representations of respective entities are generated by different cybersecurity tools implemented in the cloud environment.

17. A computer program product comprising one or more computer readable storage media, and program instructions collectively stored on the one or more computer readable storage media, the program instructions comprising instructions configured to cause one or more processors to perform a method comprising:
unifying a first representation of a first entity with a second representation of the first entity in a knowledge graph of a cloud environment based on the first representation and the second representation sharing a predefined configuration of attributes;
unifying a third representation of a second entity with a fourth representation of the second entity in the knowledge graph based on a temporal activity signature of the third representation being matched to the fourth representation by a Long-Short Term Memory (LSTM) network model; and
outputting the knowledge graph with a first unified representation of the first entity based on the first representation and the second representation and a second unified representation of the second entity based on the third representation and the fourth representation.

18. The computer program product of claim 17, wherein the first entity and the second entity are applications in the cloud environment.

19. The computer program product of claim 17, wherein the predefined configuration of attributes comprises a workload deployment name and a container image name.

20. The computer program product of claim 17, wherein respective representations of respective entities are generated by different cybersecurity tools implemented in the cloud environment.
